(19) United States
(12) Patent Application Publication
(10) Pub. No.: US 2011/0289075 A1
(43) Pub. Date: Nov. 24, 2011

(54) Music Recommender

(76) Inventor: Erik T. Nelson, Annandale, VA (US)

(21) Appl. No.: 12/785,556

(22) Filed: May 24, 2010

(51) Int. Cl. G06F 17/30

(52) U.S. Cl. 707/723; 707/769; 707/E17.014

(57) ABSTRACT

A playlist is generated and modified using a music recommender (MR). The MR may track users' actions to skip a song or listen to the songs in succession. In some embodiments, a mood may be generated by the MR by aggregating arrays of songs that users listen to consecutively based on one or more common traits. The MR may select a mood and generate a playlist automatically in some examples. The MR may be adaptive and modify the users' moods according to users' further actions.

### BRIEF DESCRIPTION OF THE SEVERAL VIEWS OF THE DRAWINGS

FIG. 1 depicts an example system for one or more embodiments of the invention.

FIG. 2 illustrates a method of generating a mood for a user, according to one embodiment.

FIG. 3 illustrates the interaction between music recommender (MR) and a user, according to one embodiment.

FIG. 4 depicts the music recommender running a selected mood, according to one embodiment.

FIG. 5 and FIG. 6 illustrate how arrays may be combined to create moods in a Basic Mode, according to one embodiment.

FIG. 7 and FIG. 8 illustrate the music recommender running in a Social Mode, according to one embodiment.

FIG. 9 is a graph showing the components of one or more embodiments of the music recommender application.

FIG. 10 depicts an example Graphic User Interface for users to interact with the music recommender application.

### DETAILED DESCRIPTION OF EMBODIMENTS

Embodiments of the invention use user actions on music playing device(s) to generate and modify playlists. For example, a music recommender may collect data from user input or import data from users' friends, create a mood by aggregating arrays of songs according to user preference, store the mood into a database and select a mood to generate a playlist based on parameters such as current time of day.

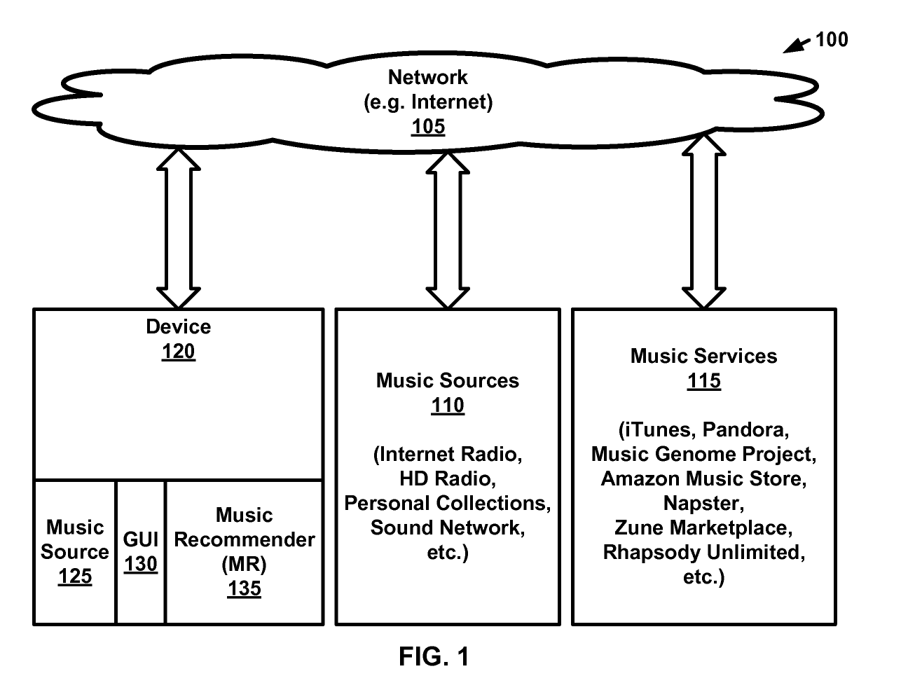

FIG. 1 depicts a diagram of an example system that may be used to implement embodiments of the invention. Device 120 may be connected to music sources 110 and music services 115 via network 105. Music sources 110 may include, but are not limited to, Internet Radio, HD Radio, Personal Collections, Sound Network, etc. Music services 115 may include, but are not limited to, iTunes, Pandora, Music Genome Project, Amazon Music Store, Napster, Zune Marketplace, Rhapsody Unlimited, etc. In another embodiment, music sources 110 may be located on device 120 performing all the functions of music sources 110 and device 120.

One skilled in the art will appreciate that network 105 is not limited to a particular type of network. For example, network 105 may feature one or more Wide Area Networks (WANs), such as the Internet. Network 105 may also feature one or more Local Area Networks (LANs) having one or more of the well-known LAN topologies. A variety of different protocols on these topologies, such as Ethernet, TCP/IP, Frame Relay, Ethernet, FTP, HTTP and the like may be used. Moreover, network 105 may feature a Public Switched Telephone Network (PSTN) featuring land-line and cellular telephone terminals, or else a network featuring a combination of any or all of the above.

Device 120 may be any one of numerous devices such as a music player device such as an ipod or MP3 player, a computer, a laptop, an electronic pad, an eReader, a electronic pad, a phone, a combination of the above, etc. In one embodiment of the invention, device 120 may include music source database 125, Graphic User Interface (GUI) 130 and Music Recommender (MR) 135. Music source database 125 may store music from music sources 110 or music services 115 or any other music the user has stored on the device 120. In this embodiment, music source database 125 may provide the songs to be played to users. Music Recommender (MR) 135 may generate moods inferred from users' actions (skip, listen or repeat) and play songs according to users' moods. GUI 130 may enable users to interact with music recommender 135 and allow users to utilize a variety of functions, such as displaying information on the songs generated from music recommender 135, skipping or repeating songs being played from music recommender 135, requesting additional information from music recommender 135, and/or customizing local and/or remote aspect of the system.

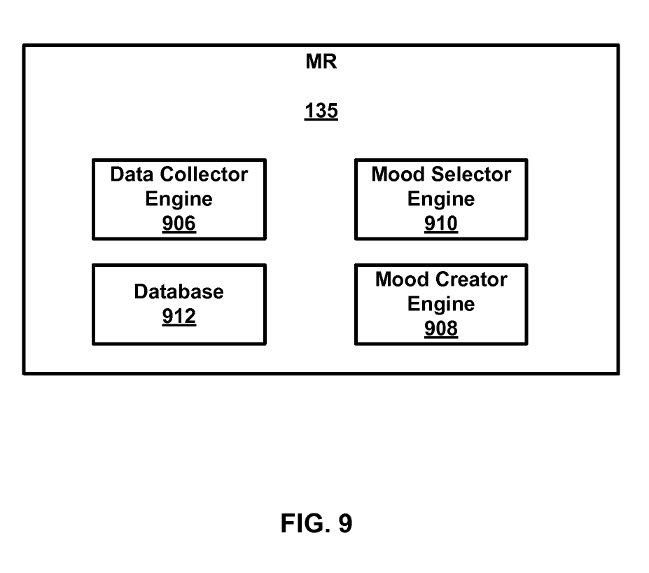

FIG. 9 depicts in more detail music recommender 135 in FIG. 1, which, according to an embodiment, may comprise data collector engine 906, mood creator engine 908, mood selector engine 910 and database 912. In some embodiments, the MR 135 and each of the component engines 906, 908, 910 and 912 may be modules, either individually, or in combination. In an embodiment, data collector engine 906 may track the songs users listen to and infer users' preferences from users' actions (skip or repeat a song) through GUI 130 (FIG. 1). Mood creator engine 908, according to one embodiment, may create moods based on information tracked by data collector engine 906 and store moods into database 912. Mood selector engine 910, according to one embodiment, may retrieve information from database 912 and select songs to play according to users' moods.

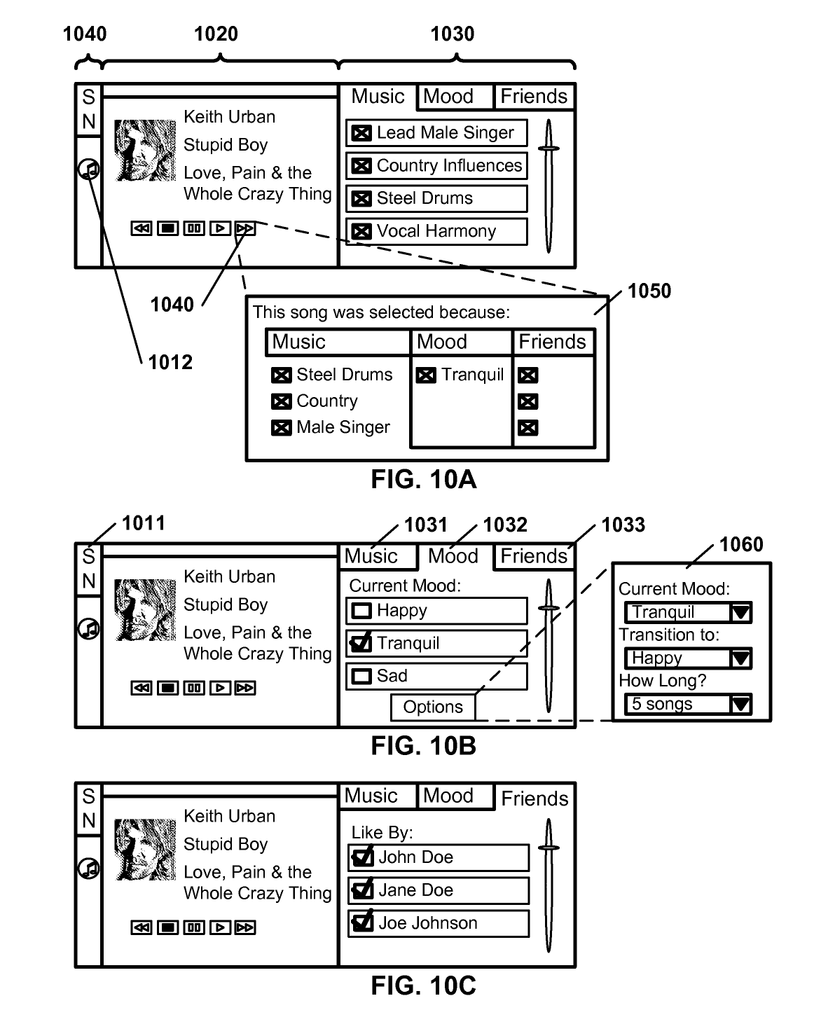

FIG. 10A, FIG. 10B and FIG. 10C depict one example Graphic User Interface 130 in FIG. 1, which, according to one embodiment, may include, but is not limited to, three panels: a left panel 1010, a middle panel 1020 and a right panel 1030.

According to this embodiment, left panel 1010 may comprise, but is not limited to, a top social networking (“SN”) tap 1011 which may connect to users' social networking profile such as Facebook while users listening to their music, and a bottom “music control” tap 1012 which may bring users to the music control panel displayed on the middle panel.

Middle panel 1020 may include the music control panel, which may display song information such as an artist's name, song name and album name, as well as music control buttons allowing users to repeat, stop, pause, play and skip a song the users listen to. For example, middle panel 1020 currently displays the song “Stupid Boy” which is from Keith Urban's album “Love, Pain and the Whole Crazy Thing.” In addition, when a skip is pressed, a popup window 1050 may appear displaying the reason why this song was selected. For example, the song “Stupid Boy” was selected because it belongs to the genres Steel Drums, Country and Male Singer; it is set to be a tranquil mood and it is liked by user's friends John, Jane and Joe.

According to this embodiment, right panel 1030 may include, but is not limited to, a Music tap 1031 (expanded in FIG. 10A), a Mood tap 1032 (expanded in FIG. 10B) and a Friends tap 1033 (expanded in FIG. 10C). The Music tap 1031 may display the genres a song belongs to. For example, the song “Stupid Boy” may belong to several genres “Lead Male Singer”, “Country Influence”, “Steel Drum” and “Vocal Harmony”. The Mood tap 1032 may demonstrate the mood the song is associated with. For example, “Stupid Boy” is associated with mood “tranquil”. The “Options” button on the “Mood” tap 1032 may enable a user to transition from current mood (e.g., Tranquil) to the next user selected mood (e.g., Happy) at a speed specified by the user (e.g., 5 songs) using options box 1060. The Friends tab 1033 may indicate the names of the user's friends who shared the same interest on the song the user is listening to. For example, “Stupid Boy” is also liked by the user's friends “John Doe”, “Jane Doe” and “Joe Johnson”. Those of ordinary skill in the art will see that many other taps and categories within these taps and other taps may be utilized.

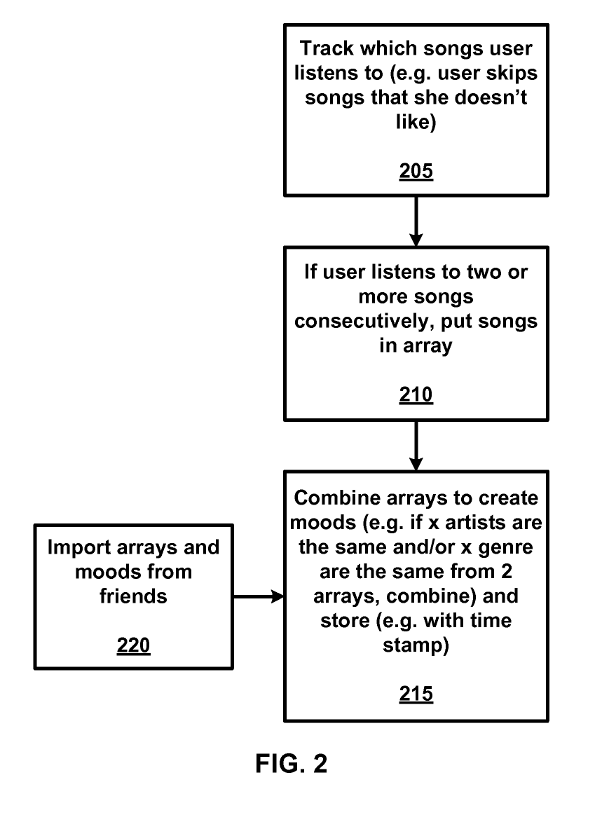

FIG. 2 illustrates a method of generating a mood for a user, according to one embodiment. In 205, songs users listen to may be tracked and song information from the tracked songs may be stored in MR 135. The song information MR 135 tracks may be, but is not limited to, a song name, artist name or genre name. The song information may be remotely received from users, for example, via network 105 in FIG. 1. Alternatively, the song information may be locally received from, for example, input by users at a stand-alone device or other computers.

In one embodiment, MR 135 in FIG. 1 may track which songs users listen to and/or which songs users skip. In 210, if a user listens to two or more songs consecutively, MR 135 may put these songs in arrays. In 215, arrays may be combined to create moods. For example, if x (e.g., one or more) artists are the same and/or x (e.g., one or more) genre are the same from two arrays, MR 135 may combine the arrays to form a mood and store the mood in the database with a time stamp. In another example, if x (e.g., one or more) song names are the same and/or x (e.g., one or more) artists are the same from two arrays, MR 135 may combine these arrays to form a mood. In a third example, if x (e.g., one or more) song names are the same and/or x (e.g., one or more) genre are the same from two arrays, MR 135 may combine the arrays to form a mood.

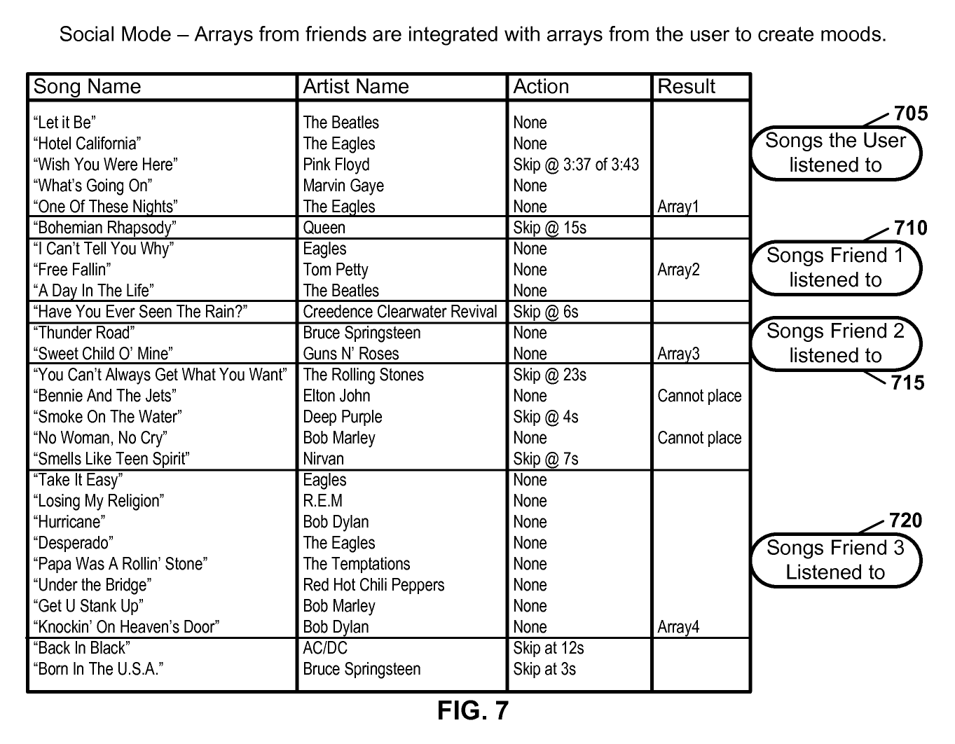

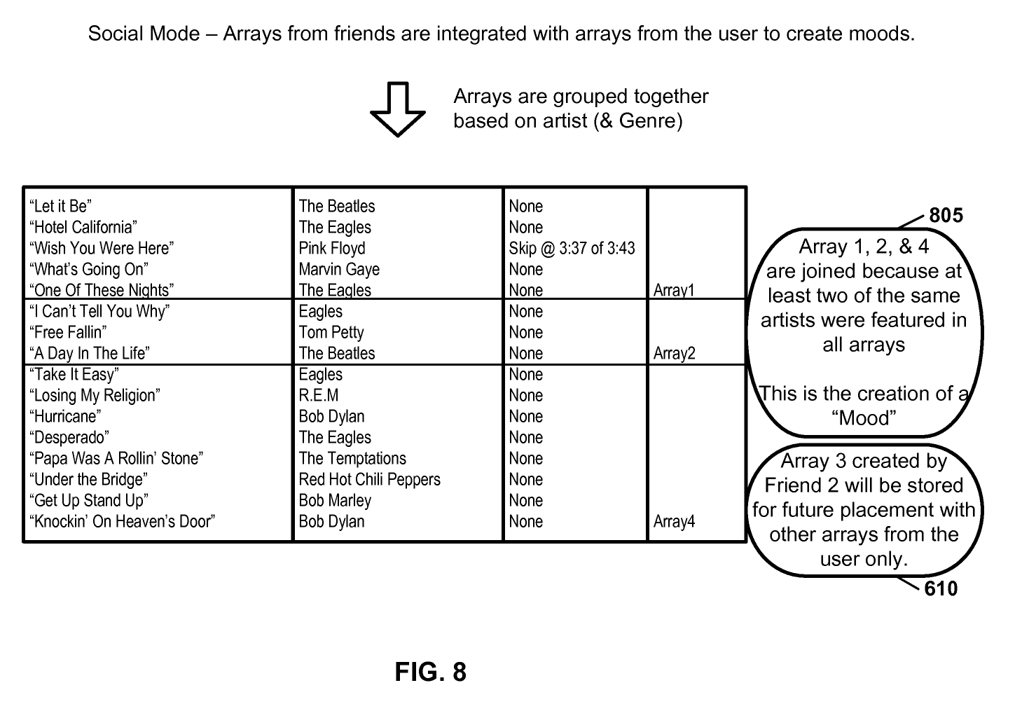

In 220, MR 135 may import arrays and moods from friends under a social mode, which will be described further in FIG. 7 and FIG. 8.

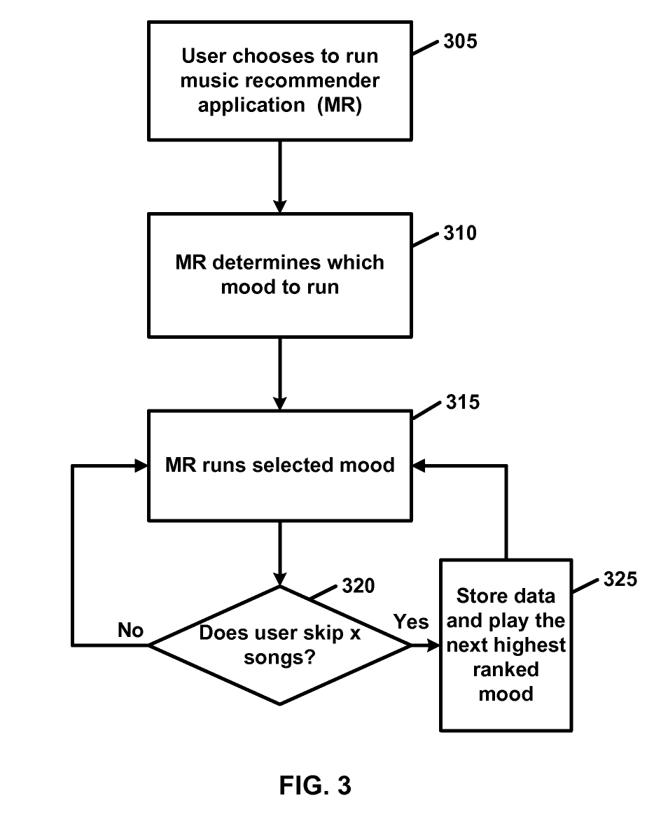

FIG. 3 illustrates the interaction between music recommender (MR) 135 and users, according to one embodiment. In 305, users may choose to run MR 135. In 310, MR 135 may determine which moods to run. In 315, MR 135 may run the selected moods. In 320, it may be determined whether users skip x (e.g., one or more) songs consecutively. If yes, in 325, MR 135 may store this information and select new moods to run. If no, users do not skip x (e.g., one or more) songs consecutively, the process may return to 315 and MR 135 may continue to run the current mood.

In some embodiments, based on the music that users listen to or the moods that users are in, MR 135 may also suggest songs from an external database which are not on the users' internal database, which the users may preview and buy.

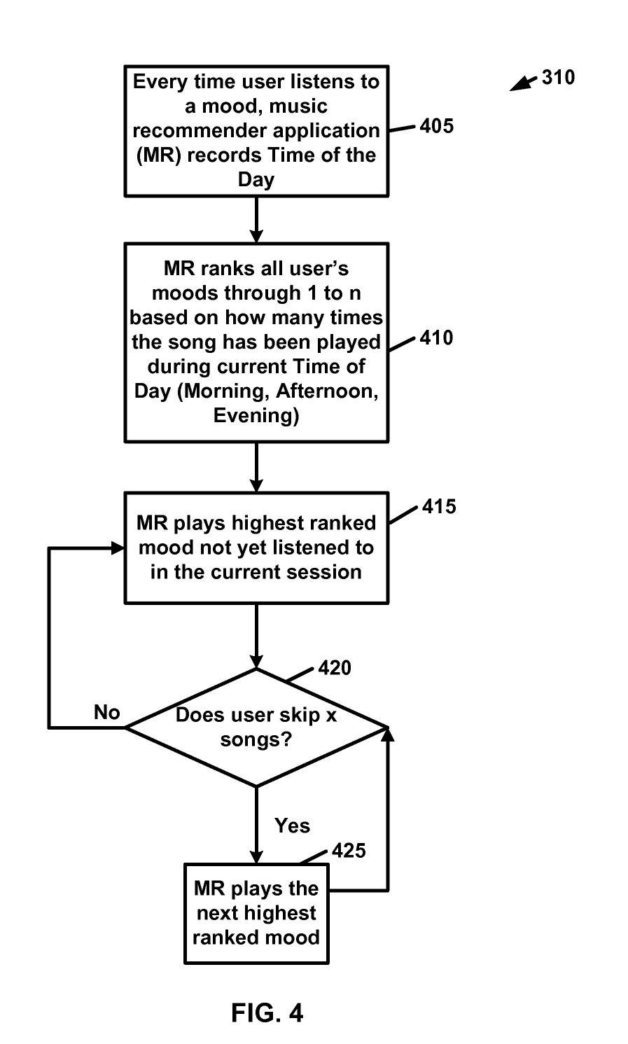

FIG. 4 depicts in more detail 310 in FIG. 3, which relates to an embodiment where MR 135 runs a selected mood. In 405, every time a user listens to a mood, MR 135 may record a time stamp such as Time of the Day (Morning, Afternoon or Evening). In 410, MR 135 may rank all the user's moods from 1 to n based on how many times the songs have been played during current Time of Day. In 415, MR 135 may play highest ranked mood that the user has not yet listened to in the current session. In 420, it may be determined whether the user skip x (e.g., 2, 3, 4) songs in a row. If yes, as in 425, MR 135 may play the next highest ranked mood. If no, the user does not skip x songs and listens continuously, the process may return to 415, and MR 135 may continue to play the current mood in the current session.

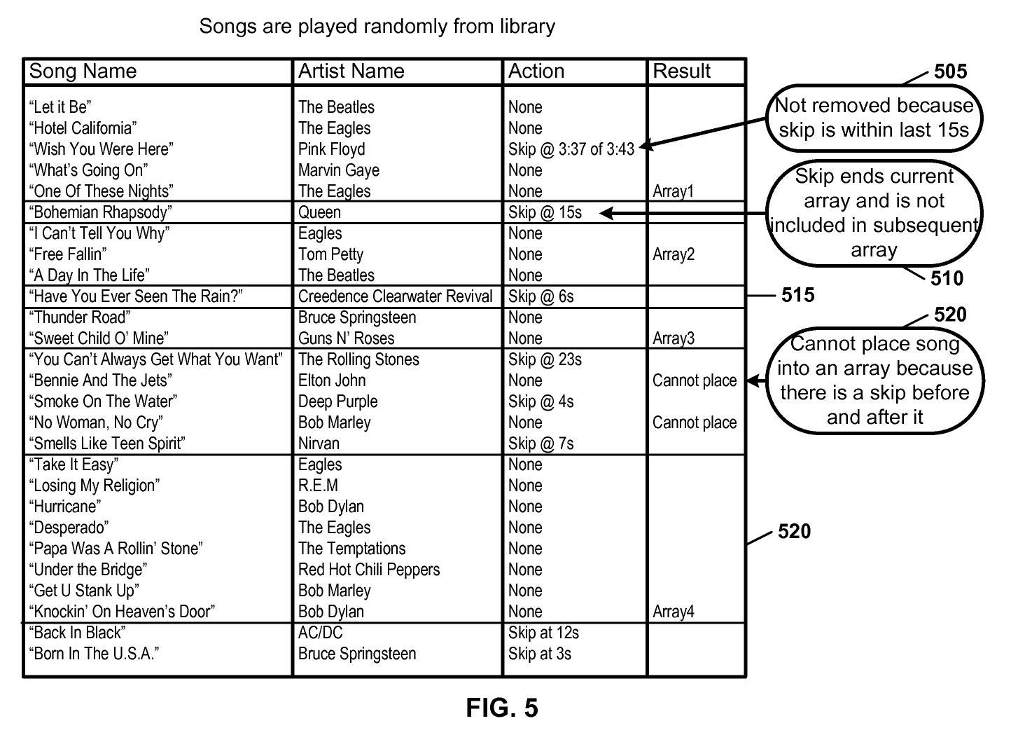

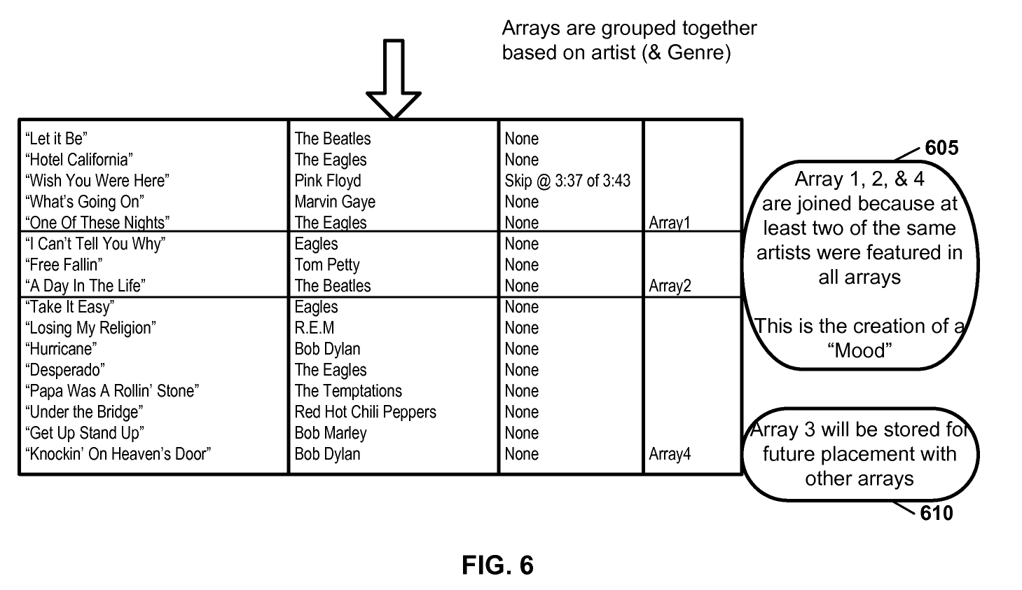

FIG. 5 and FIG. 6, illustrate how arrays may be combined to create moods in a Basic Mode, meaning no prior users' information on songs may be available to MR 135. In FIG. 5, songs may be played randomly from the music sources (110 in FIG. 1) or the music source database (125 in FIG. 1) or the music services (115 in FIG. 1). The user listens to the songs consecutively to form array 1. In 505, the user skips the song named “Wish You Were Here” at 3:37 of 3:43. This song would not be removed from the array because the skip occurs within last 15 seconds of the song. In 510, user skips the song named “Bohemian Rhapsody” at 15 seconds, which may terminate the current array 1 and this song would not be included in the subsequent array 2.

In 515, for example, user skips the song “Have You Ever See the Rain” at 6 seconds, which may end array 2 and start array 3. In 520, MR 135 cannot put the songs “You Can't Always Get What You Want”, “Bennie and the Jets”, “Smoke on the Water”, “No Woman, No Cry” and “Smell Like Teen Spirit” into an array because there is a skip before and after each song, which may terminate array 3 and starts array 4. In 525, for example, the user listens to six songs consecutively, which may form array 4.

In FIG. 6, according to one embodiment, arrays may be grouped together based on artist names and/or genre names. In 605, array 1, 2, and 4 may be joined because at least two of the same artists are featured in all arrays. This may be the creation of a “Mood”. In 610, array 3 may be stored for future placement with other arrays.

FIG. 7 and FIG. 8 illustrate a Social Mode and how arrays from friends may be integrated with arrays from the user to create moods, according to one embodiment. Because friends may typically have similar tastes in music, MR 135 may tap into a user's social networking sites and utilize moods set up by friends.

In 705, for example, array 1 may be composed by songs the user listens to in succession. In 710, array 2 may be composed of songs Friend 1 listens to in succession. In 715 and 720, array 3 and array 4 may be composed of songs Friend 2 and Friend 3 listen in succession respectively.

In FIG. 8, according to one embodiment, arrays may be grouped together based on artist names and/or genre names. In 805, array 1, 2, and 4 may be joined because at least two of the same artists are featured in all arrays. This may be the creation of a “Mood”. In 810, array 3 created by Friend 2 may be stored for future placement with other arrays from the user only.

Embodiments may be implemented using a non-transient computer readable medium containing computer instructions configured to be executed by one or more processors. The one or more processors may reside on one or more music playing devices. Alternatively, the one or more processors may reside on one or more devices that is/are separate and distinct from the music playing device(s). In yet another embodiment, the one or more processors may reside on one or more music playing devices and one or more devices that is/are separate and distinct from the music playing device(s).

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. Thus, the present embodiments should not be limited by any of the above described example embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A non-transient computer readable medium containing computer instructions that when executed by one or more processors, causes the one or more processors to perform a method for generating one or more playlists for one or more users, the method comprising:
a. generating, utilizing one or more music recommender mood creator engines, one or more arrays that correspond to one or more songs that one or more users listen to using a music playing device;
b. generating, utilizing one or more music recommender mood creator engines, one or more moods based on one or more similar characteristics of the arrays and storing the one or more moods in one or more databases; and
c. selecting, utilizing one or more music recommender mood selector engines, one or more items for one or more playlists based on the one or more moods in the one or more databases.

2. The method of claim 1, further comprising tracking, utilizing one or more music recommender data collector engines, information associated with the one or more songs that the one or more users listen to.

3. The method of claim 2, wherein the tracked information is one or more song names.

4. The method of claim 2, wherein the tracked information is one or more artist names.

5. The method of claim 4 wherein generating, utilizing one or more music recommender mood creator engines, the one or more moods includes combining 2 or more arrays wherein at least n same artist names are featured in the arrays, wherein n is an integer.

6. The method of claim 2 wherein the tracked information is one or more genre names.

7. The method of claim 6 wherein generating, utilizing one or more music recommender mood creator engines, the one or more moods includes combining two or more arrays wherein at least n same genre names are featured in the arrays, wherein n is an integer.

8. The method of claim 2 wherein generating, utilizing one or more music recommender mood creator engines, the one or more arrays includes combining two or more songs that the user listens to consecutively and storing the songs in one or more arrays.

9. The method of claim 2 wherein generating, utilizing one or more music recommender mood creator engines, one or more moods includes storing the one or more moods with one or more associated Times of Day into one or more databases.

10. The method of claim 9 wherein the one or more associated Times of Day comprises Morning, Afternoon, Evening or any combination thereof.

11. The method of claim 2 wherein generating, utilizing one or more music recommender mood creator engines, the one or more arrays includes importing one or more arrays from one or more friends.

12. The method of claim 2 wherein generating, utilizing one or more music recommender mood creator engines, the one or more moods includes importing one or more moods from one or more friends.

13. The method of claim 2 wherein selecting, utilizing one or more music recommender mood selector engines, includes ranking the one or more users' one or more moods from 1 to n, wherein n is an integer.

14. The method of claim 13 wherein ranking, utilizing one or more music recommender mood selector engines, is further based on how many times the one or more moods have been played in one or more Times of Day.

15. The method of claim 14 wherein selecting, utilizing one or more music recommender mood selector engines, further includes playing one or more highest ranked moods associated with the current one or more Times of Day not yet listened to in the current session.

16. The method of claim 13 wherein selecting, utilizing one or more music recommender mood selector engines, further includes skipping one or more moods and playing the next ranked one or more moods if the one or more users skip two songs in a row from the one or more moods.

17. The method of claim 16 wherein selecting, utilizing one or more music recommender mood selector engines, further includes downgrading the one or more skipped moods and updating the one or more moods' ranking in the one or more databases.

18. The method of claim 2 further comprising providing, utilizing one or more music recommender mood selector engines, content to the one or more users according to the one or more playlists.

19. The method of claim 18 wherein providing, utilizing one or more music recommender mood selector engines, includes streaming the content to the one or more users through one or more computer networks.

20. The method of claim 18 wherein the one or more processors and the non-transient computer readable medium reside on the music playing device.
